(19) United States
(12) Patent Application Publication
(10) Pub. No.: US 2006/0265650 A1
(43) Pub. Date: Nov. 23, 2006

(54) Method for executing GUI based on message Q

(75) Inventor: Young-seuk Oh, Seoul (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/390,440

(22) Filed: Mar. 28, 2006

(30) Foreign Application Priority Data
May 23, 2005 (KR) 2005-43069

(51) Int. Cl. G09G 5/02

(52) U.S. Cl. 715/700; 345/594

(57) ABSTRACT

A method for executing a GUI based on a message Q provided from an embedded operating system (OS) in an electronic device. The method includes by a navigation task generating a “GUI execution message”, the navigation task being operated to control an operation of an electronic device, and by a GUI task executing a GUI according to the “GUI execution message” generated by the navigation task, the GUI task being operated independently from the navigation task to execute the GUI. Accordingly, the GUI is executed based on a message Q provided from an embedded OS, and thus, the GUI is applicable in any electronic device.

### CROSS-REFERENCE TO RELATED APPLICATIONS

This application claims all benefits accruing under 35 U.S.C. § 119 from Korean Patent Application No. 2005-43069, filed on May 23, 2005, the disclosure of which is incorporated by reference herein.

### BACKGROUND OF THE INVENTION

1. Field of the Invention

The present invention relates to a graphic user interface (GUI), and more particularly, relates to a method for executing a GUI based on a message Q provided from an embedded operating system (OS).

2. Related Art

A graphic user interface (GUI) is a program interface that allows a user to take advantage of an electronic device's graphics capabilities to make a program easier to use. GUIs are developed to reduce the inconvenience of typical user interfaces which require a user to input data using a keyboard and to memorize a considerable number of complex commands.

Most existing operating systems support GUIs, and many application programs use specific GUI elements with different features to display information or allow the user to interact with the program. Examples of operating systems (OS) for use in an electronic device, such as an image device or a communication device to support GUIs include, but not limited to, VxWorks, QNX, Windows CE and Palm OS. Examples of basic GUI elements include windows, menus, buttons, check boxes, pointers, icons and other gadgets used to carry out commands without learning complex command languages. For example, a pointer is a symbol that appears on a display screen and that can be moved by a user, via a pointing device such as a mouse or trackball, to select objects and commands on the display screen. An icon is a small picture that represents commands, files or windows and that can be moved by the user, via a pointing device, around the display screen. If the pointer is moved to the icon and a mouse button is pressed, a command can be executed or the icon can be converted into a window. A user may set options in an electronic device or may control the operation of the electronic device by using a GUI.

Since most electronic devices employ the GUI for the user's convenience, the GUI must be easily installed in the electronic device. In order to execute the GUI in those electronic devices, a GUI providing program must be included in a driving program of the electronic device. However, the GUI providing program has to be created and/or modified depending on the kinds of electronic devices. This requirement can be extremely inconvenience and has become increasingly problematic as many GUIs have become increasingly sophisticated with various functions.

Therefore, there is a need for a new GUI executing method that is applicable to any electronic device. This way the GUI providing program does not have to be created and/or modified for each electronic device.

### SUMMARY OF THE INVENTION

Various aspects and example embodiments of the present invention provide a method for executing a GUI based on a message Q provided from an embedded operating system (OS), and a message structure suitable for execution of a GUI based on a message Q.

Additional aspects and/or advantages of the invention will be set forth in part in the description which follows and, in part, will be obvious from the description, or may be learned by practice of the invention.

In accordance with an aspect of the present invention, a method for executing a graphic user interface (GUI) in an electronic device, comprises: generating a “GUI execution message”, by a navigation task operated to control an operation of the electronic device; and executing a GUI, by a GUI task, according to the “GUI execution message” generated by the navigation task, the GUI task being operated independently from the navigation task to execute the GUI.

Preferably, but not necessarily, the “GUI execution message” includes at least one field that describes a graphic to be displayed on a display.

Preferably, but not necessarily, the “GUI execution message” includes a graphic processing field that describes a content about a graphic processing to be executed by the GUI task.

Preferably, but not necessarily, the graphic processing field describes at least one of information about a field describing a graphic which is to be displayed on the display by the GUI task and a display processing method of the graphic.

Preferably, but not necessarily, the “GUI execution message” includes a field that describes information about parameter fields having a changed content among parameter fields describing a content about the graphic to be displayed.

Preferably, but not necessarily, the “GUI execution message” includes a field that describes a number of parameter fields which is in use among parameter fields describing a content about the graphic to be displayed on the display.

Preferably, but not necessarily, the “GUI execution message” includes a field that describes at least one of information about an image to be reproduced by the electronic device and a message to be provided to a user from the navigation task.

Preferably, but not necessarily, a “GUI execution status message” is further generated by the GUI task, and a GUI execution status is further identified by the navigation task with reference to the “GUI execution status message” generated by the GUI task.

Preferably, but not necessarily, a structure of the “GUI execution status message” is the same as that of the “GUI execution message”.

Preferably, but not necessarily, the “GUI execution status message” includes a field that describes information about a graphic displayed on the display.

Preferably, but not necessarily, the “GUI execution status message” includes a field that describes information about a position of a cursor displayed on the display.

In accordance with another aspect of the present invention, an electronic device comprises an embedded operating system (OS) deployed to operate the electronic device; and a graphic user interface (GUI) installed to enable a user to interact with the electronic device, wherein the GUI is configured to accept a navigation task to control an operation of the electronic device and a GUI task operable independently from the navigation task to execute the GUI, and wherein the navigation task generates a “GUI execution message” and the GUI task executes the GUI according to the “GUI execution message” generated by the navigation task.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates a method for executing a GUI based on a message Q according to an embodiment of the present invention;

FIG. 2 illustrates an example structure of a message transmitted and received between the navigation task and the GUI task shown in FIG. 1;

FIG. 3A illustrates an example of information described by a VP field in an example message shown in FIG. 2;

FIG. 3B illustrates an example structure of an individual P field included in an example message shown in FIG. 2; and

FIG. 4 illustrates an example message to display “PLAY_ICON” on a display according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

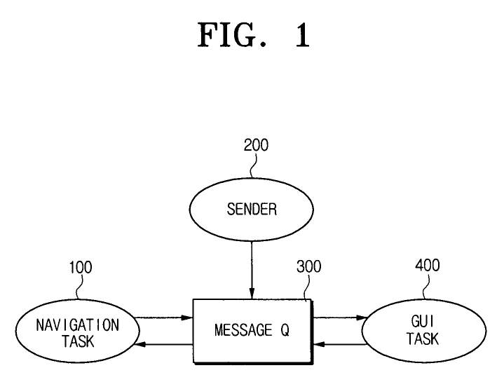

FIG. 1 is a view to explain a method for executing a GUI based on a message Q according to an embodiment of the present invention. FIG. 1 shows a navigation task 100, a sender 200, a message Q 300, and a GUI task 400 from a GUI.

The navigation task 100 is operated to control an operation of an electronic device. The representative example of the electronic device is an image device or a communication device. The GUI task 400 is operated independently from the navigation task 100 to execute a GUI. The message Q 300 records a message generated by a task, and the sender 200 transmits the message recorded to the message Q 300 to another task.

As shown in FIG. 1, the navigation task 100 and the GUI task 400 receive and transmit messages from and to each other through the message Q 300. More specifically, the message that is generated at the navigation task 100 and then recorded to the message Q 300 is transmitted to the GUI task 400 by the sender 200. In the same way, the message generated at the GUI task 400 and then recorded to the message Q 300 is transmitted to the navigation task 100 by the sender 200.

The GUI task 400 executes a GUI by transmitting and receiving a message with respect to the navigation task 100. Specifically, the GUI task 400 executes a GUI according to “GUI execution message” generated by the navigation task 100. The “GUI execution message” indicates a graphic to be displayed on a display (not shown) and a display processing method of the graphic displayed on a display (not shown). The structure of the “GUI execution message” will be described below.

The navigation task 100 identifies the execution status of the GUI by transmitting and receiving a message with respect to the GUI task 400. More particularly, the navigation task 100 identifies the execution status of the GUI by referring to a “GUI execution status message” generated by the GUI task 400. Herein, the “GUI execution status message” indicates a graphic displayed on the display (not shown) and a position of a cursor.

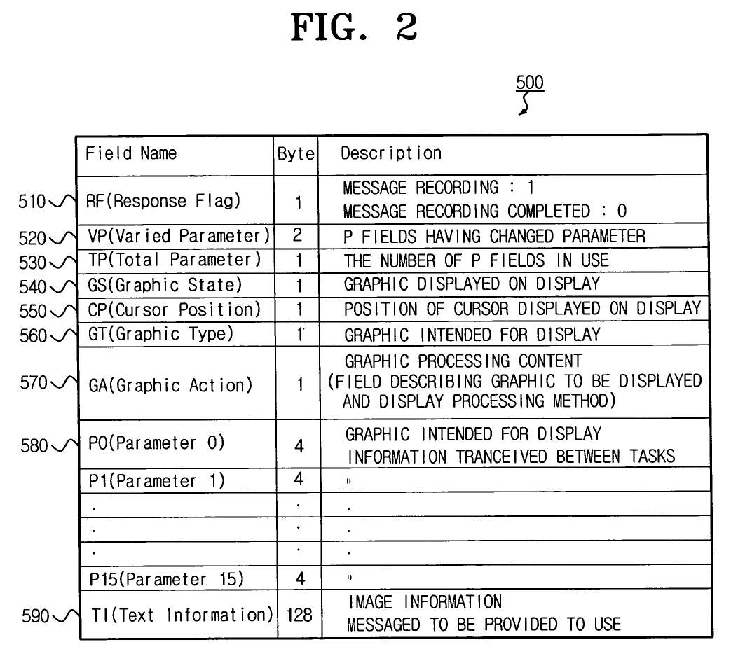

Hereinafter, structures of the “GUI execution message” and the “GUI execution status message” are described. In this embodiment, the structure of the “GUI execution message” is the same as that of the “GUI execution status message.” Both the “GUI execution message” and the “GUI execution status message” can be referred to as a “message”, and the structure of such a message will be described with reference to FIG. 2 herein below.

Referring to FIG. 2, the message 500 comprises several fields indicating different types of information regarding the message, including, for example, a message recording, a number of fields in use or having changed parameters, a graphic to be displayed on a display, a position of cursor displayed on a display, a graphic processing content and other image information. In particular, the message 500 contains a response flag (RF) field 510, a varied parameter (VP) field 520, a total parameter (TP) field 530, a graphic state (GS) field 540, a cursor position (CP) field 550, a graphic type (GT) field 560, a graphic action (GA) field 570, parameter (P) fields (P0 to P15 fields) 580, and a text information (TI) field 590. The total length of the message is 200 byte.

The RF field 510 helps the message to be normally transceived, i.e., transmitted and/or received between the navigation task 100 and the GUI task 400. The RF field 510 is set to “1” during a process of recording the message generated by a task to the message Q 300 so that another task is not able to read the recording message. When the recording of the message to the message Q 300 is completed, the RF field 510 is set to “0” so that another task is able to read the recording-completed message.

However, if the sender 200 manages the message transmission and reception between the tasks, the RF field 510 may not be used. However, the RF field 510 is used when it is impossible to transmit and receive a message between tasks through the sender 200.

The VP field 520 describes information about P fields having a changed parameter among the 16 P fields (P0 to P15). The VP field 520 is assigned with 2 byte.

The VP field 520 describes the information about the P fields having the changed parameter in the following way. If a P field has a changed parameter, the P is set to “1”, and if a P field has an unchanged parameter, the P field is set to “0”.

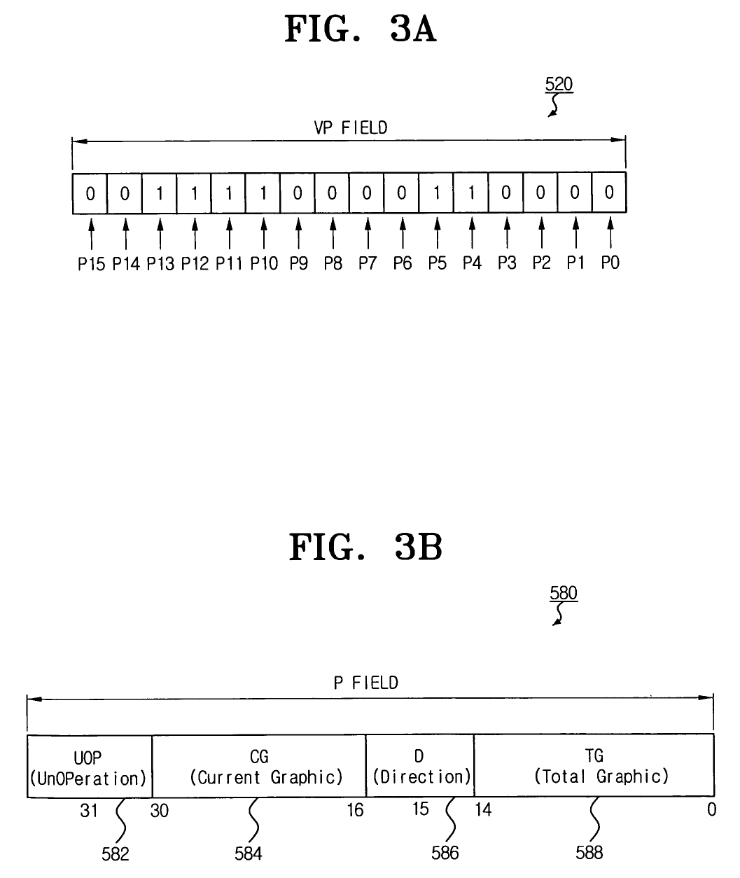

For example, if the information described in the VP field 520 is “0 0 1 1 1 1 0 0 0 0 1 1 0 0 0 0” as shown in FIG. 3A, P fields P4, P5, P10, P11, P12, and P13, indicated by “1” has changed parameters.

If the VP field 520 is used, the tasks read out only the P fields having the changed parameters, but do not read the P field having the unchanged parameter. Accordingly, a work for reading is greatly reduced.

The TP field 530 describes the total number of P fields which are in use. The TP field 530 is assigned with 1 byte. Although the total number of P fields provided in the message, as shown, for example, in FIG. 2 is sixteen (16), all of the P fields are not used. A part of the P fields may be used, or alternatively, no P field is used. When a part of P fields is used, the TP field 530 informs the total number of P fields which are in use.

If the TP field 530 is used, the tasks read only the P fields which are is in use and do not read the P fields which are not in use. Therefore, a work for reading is greatly reduced.

The GS field 540 describes information about the graphic displayed on the display (not shown). The GS field 540 is assigned with 1 byte. The GS field 540 is settable only by the GUI task 400 because the graphic is displayed only by the GUI task 400.

The navigation task 100 is not able to set the GS field 540 but is able to refer to the GS field 540. With reference to the GS field 540, the navigation task 400 is aware of a current graphic which is being displayed on the display.

The CP field 550 describes information about a position of a cursor displayed on the display. The CP field 550 is assigned with 1 byte. The CP field 550 is settable only by the GUI task 400 because the cursor is displayed only by the GUI task 400.

The navigation task 100 is not able to set the CP field 550 but is able to refer to the CP field 550. With reference to the CP field 550, the navigation task 100 is aware of a current position of the cursor displayed on the display.

The GT field 560 describes a graphic intended to be displayed on the display. The GT field 560 is assigned with 1 byte. The navigation task 100 determines which graphic is intended for the display. Accordingly, the GT field 560 is settable only by the navigation task 100.

The GUI task 400 is not able to set the GT field 560 but is able to refer to the GT field 560. With reference to the GT field 560, the GUI task 400 is aware of the graphic intended for the display.

The GA field 570 describes a graphic processing content to be executed by the GUI task 400. More specifically, the GA field 570 describes information regarding a graphic to be displayed on the display by the GUI task 400 and a display processing method for the graphic.

For example, the GA field 570 describes contents as follows: (i) a content to display the graphic described by the GT field 560, (ii) a content to delete the graphics described by the P1 and P2 fields, and (iii) a content to change a currently displayed graphic according to a content described by changed P fields with reference to the VP field 520.

The GA field 570 is assigned with 1 byte. The navigation task 100 determines the contents about the graphic processing to be executed by the GUI task 400. Accordingly, the GA field 570 is settable only by the navigation task 100.

The GUI task 400 is not able to set the GA field 570 but is able to refer to the GA field 570. The GUI task 400 processes the graphic with reference to the GA field 570 and according to the determined display processing and the displayed graphic.

The P fields (P0 to P15) describe a graphic to be displayed on the display and information transmitted and received between the navigation task 100 and the GUI task 400. Each P field is assigned with 4 byte.

The graphic intended for the display is also describable by the GT field 560. However, since the GT field 560 is assigned with 1 byte, a relatively simple graphic is described by the GT field 560, whereas a relatively complicated graphic is described by the P field.

If it is impossible for the GUI task 400 to execute the GUI according to the “GUI execution message” generated by the navigation task 100, the P field may be used to notify the navigation task 100 of the execution.

If it is necessary to change the graphic to be displayed on the display upon receiving an input from a user through the GUI, the P field 580 is used for the GUI task 400 to inform the navigation task 100 of the presence of the user's input to know a content to be modified. The user's input may be a right/left direction key manipulation or an up/down direction key manipulation.

The structure of the P field 580 as explained above is shown in FIG. 3B. As shown in FIG. 3B, the P field 580 comprises an unoperation (UOP) sub-field 582, a current graphic (CG) sub-field 584, a direction (D) sub-field 586, and a total graphic (TG) sub-field 588.

If it impossible for the GUI task 400 to execute the GUI according to the “GUI execution message” generated by the navigation task 100, the UOP sub-field 582 may be used to notify the navigation task 100 of the execution. If the UOP sub-field 582 is set to “1”, the UPO sub-field 582 indicates that it is impossible to execute the GUI.

The D sub-field 586 is used for the GUI task 400 to inform the navigation task 100 of the presence of user's input. The D sub-field 586 indicates whether the user's input is the right direction manipulation or the left direction manipulation, or whether it is the up direction manipulation or the down direction manipulation.

The CG sub-field 584 indicates a current graphic which is being displayed on the display, and the TG sub-field 588 indicates graphics which can replace the current graphic displayed on the display.

The GUI task 400 displays a graphic on the display according to the user's input and referring to the CG sub-field 584 and the TG sub-field 588, as shown in FIG. 3B. For example, if the TG sub-field 588 describes graphic A, graphic B, and graphic C, the graphics A, B, and C are displayed in sequence and repeatedly whenever a user manipulates a direction key. If the CG sub-field 584 describes the graphic B, the GUI task 400 displays the graphic C upon receiving one direction key manipulation from the user. If the CG sub-field 584 describes the graphic C, the GUI task 400 displays the graphic A upon receiving one direction key manipulation from the user. This is because the GUI task 400 knows as a result of referring to the TG sub-field 588 that the next graphic of the graphic C is the graphic A.

Referring back to FIG. 2, the TI field 590 describes information about an image reproduced by the electronic device and a message that the navigation task 100 intends to provide to the user. One example of the information about the image is a title. The representative example of the message provided by the navigation task 100 is an error message or an alarming message.

The TI field 590 is assigned with 128 byte. If the TI field 590 is assigned with more than 128 byte, the GUI task 400 may not implement a graphic processing with respect to bytes which are left after 128 byte.

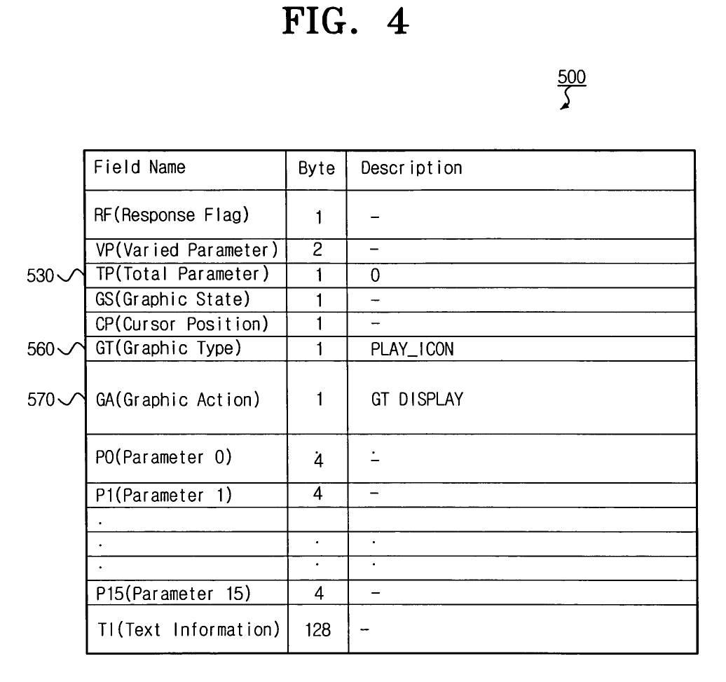

Up to now, the structure of the message transmitted and received between the navigation task 100 and the GUI task 400 has been described in detail. FIG. 4 shows an example of a message processed to display ‘PLAY_ICON’ on the display. The message is generated by the navigation task 100 and transmitted to the GUI task 400.

As shown in FIG. 4, the TP field 530 is set to “0” since there is no P field 580 used. The GT field 560 describes the graphic “PLAY_ICON” to be displayed on the display, and the GA field 570 describes a content to display the graphic described by the GT field 560.

The method for executing the GUI based on the message Q can be embodied in an electronic device having an operating system (OP) embedded therein. As previously discussed, one example of such an OS is a VxWorks. However, other existing embedded OS such as QNX, Windows CE and Palm OS, can also be utilized. In addition, the message of the present invention does not necessarily comply with the structure of the message shown in FIG. 2, FIGS. 3A-3B and FIG. 4. If necessary, a field may be omitted or a new field may be added. The length of the field is also adjustable.

According to the present invention, it is possible to execute the GUI based on the message Q provided from the embedded OS. Accordingly, the GUI can be easily applied to any electronic device. In addition, an effort and a time required to change the GUI for each electronic device can be reduced significantly. In other words, GUI providing programs no longer need to be created and/or modified for each electronic device.

Various aspects and example embodiments of the present invention can be written as computer programs and can be implemented in general-use digital computers that execute the programs using a computer readable recording medium. Examples of the computer readable recording medium include magnetic storage media (e.g., ROM, RAM, floppy disks, hard disks, etc.), optical recording media (e.g., CD-ROMs, DVDs, etc.), and storage media such as carrier waves (e.g., transmission through the Internet). The computer readable recording medium can also be distributed over network coupled computer systems so that the computer readable code is stored and executed in a distributed fashion. Functional programs, codes and code segments for embodying the present invention may be easily deducted by programmers in the relevant art.

In addition, the method for executing a GUI based on a message Q, as shown in FIG. 1, can be implemented as a library, or an application framework. Such a method can be a software module written in different computer programming languages, including, but not limited to C, C++, C#, Java and Delphi, and can be integrated in either the operating system (OS) or the GUI, or alternatively, resides as a separate layer on top of the operating system (OS) or the GUI.

While there have been illustrated and described what are considered to be example embodiments of the present invention, it will be understood by those skilled in the art that various changes in form and modification may be made therein, and equivalents may be substituted for elements thereof without departing from the spirit and scope of the present invention. For example, the GUI element as described in connection with FIG. 2, FIGS. 3A-3B and FIG. 4 can vary, so long as the GUI is executed based on a message Q provided from an embedded operating system (OS). Similarly, examples of an operating system (OS) for an electronic device such as a computer system used to support GUIs, include, but not limited to, Apple Mac OS, Microsoft Windows (Windows 95, Windows XP or Windows 2000), NEXTSTEP and the X Window system. Similarly, a central controller can be implemented as a chipset, or alternatively, a general or special purposed computer programmed to perform the methods as described with reference to FIG. 3. Accordingly, it is intended, therefore, that that present invention not be limited to the various example embodiments disclosed, but that the present invention includes all embodiments falling within the scope of the appended claims.

What is claimed is:

1. A method for executing a graphic user interface (GUI) in an electronic device, comprising:
generating a “GUI execution message”, by a navigation task operated to control an operation of the electronic device; and
executing a GUI, by a GUI task, according to the “GUI execution message” generated by the navigation task, the GUI task being operated independently from the navigation task to execute the GUI.

2. The method as claimed in claim 1, wherein the “GUI execution message” comprises at least one field arranged to describe a graphic to be displayed on a display.

3. The method as claimed in claim 1, wherein the “GUI execution message” comprises a graphic processing field arranged to describe a content of a graphic processing to be executed by the GUI task.

4. The method as claimed in claim 3, wherein the graphic processing field describes at least one of information about a field describing a graphic which is to be displayed on the display by the GUI task and a display processing method of the graphic.

5. The method as claimed in claim 1, wherein the “GUI execution message” comprises a field that describes information about parameter fields having a changed content among parameter fields describing a content about the graphic to be displayed on a display.

6. The method as claimed in claim 1, wherein the “GUI execution message” comprises a field that describes a number of parameter fields which is in use among parameter fields describing a content about the graphic to be displayed on a display.

7. The method as claimed in claim 1, wherein the “GUI execution message” comprises a field arranged to describe at least one of information about an image to be reproduced by the electronic device and a message to be provided to a user from the navigation task.

8. The method as claimed in claim 1, further comprising:
generating a “GUI execution status message” by the GUI task; and
identifying a GUI execution status, by the navigation task, with reference to the “GUI execution status message” generated by the GUI task.

9. The method as claimed in claim 8, wherein a structure of the “GUI execution status message” is the same as that of the “GUI execution message”.

10. The method as claimed in claim 8, wherein the “GUI execution status message” comprises a field arranged to describe information about a graphic displayed on a display.

11. The method as claimed in claim 8, wherein the “GUI execution status message” comprises a field arranged to describe information about a position of a cursor displayed on a display.

12. An electronic device comprising:
an embedded operating system (OS) deployed to operate the electronic device; and
a graphic user interface (GUI) installed to enable a user to interact with the electronic device,
wherein the GUI is configured to accept a navigation task to control an operation of the electronic device and a GUI task operable independently from the navigation task to execute the GUI, and
wherein the navigation task generates a “GUI execution message”, and the GUI task executes the GUI according to the “GUI execution message” generated by the navigation task.

13. The electronic device as claimed in claim 12, wherein the “GUI execution message” comprises at least one field arranged to describe a graphic to be displayed on a display.

14. The electronic device as claimed in claim 12, wherein the “GUI execution message” comprises a graphic processing field arranged to describe a content of a graphic processing to be executed by the GUI task.

15. The electronic device as claimed in claim 13, wherein the graphic processing field describes at least one of information about a field describing a graphic which is to be displayed on the display by the GUI task and a display processing method of the graphic.

16. The electronic device as claimed in claim 13, wherein the “GUI execution message” comprises a field that describes information about parameter fields having a changed content among parameter fields describing a content about the graphic to be displayed on a display.

17. The electronic device as claimed in claim 13, wherein the “GUI execution message” comprises a field that describes a number of parameter fields which is in use among parameter fields describing a content about the graphic to be displayed on a display.

18. The electronic device as claimed in claim 13, wherein the “GUI execution message” comprises a field arranged to describe at least one of information about an image to be reproduced by the electronic device and a message to be provided to a user from the navigation task.

19. The electronic device as claimed in claim 13, wherein the GUI task further generates a “GUI execution status message”, and the navigation task identifies a “GUI execution status” with reference to the “GUI execution status message” generated by the GUI task.

20. The electronic device as claimed in claim 13, wherein a structure of the “GUI execution status message” is the same as that of the “GUI execution message”.
